(19) United States
(12) Patent Application Publication
(10) Pub. No.: US 2010/0093943 A1
(43) Pub. Date: Apr. 15, 2010

(54) REACTIVE ESTERS AS PLASTICIZERS FOR ELASTOMERS

(75) Inventors: Stephen O'Rourke, Bolingbrook, IL (US); John English, Oak Lawn, IL (US); Kimberly L. Stefanisin, Oak Lawn, IL (US)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: HALLSTAR INNOVATIONS CORP., Chicago, IL (US)

(21) Appl. No.: 12/250,938

(22) Filed: Oct. 14, 2008

(51) Int. Cl. C08F 36/06; C08F 36/08; C08F 114/02; C08F 8/14; C08F 20/02; C08F 20/06; C08F 20/42

(52) U.S. Cl. 525/327.3; 525/333.2; 525/329.3; 525/330.8; 525/333.1; 525/331.4; 525/330.1

(57) ABSTRACT

The present disclosure is directed to plasticized elastomer compositions and methods of preparing plasticized elastomers. The plasticized elastomer compositions comprise an elastomer, and an unsaturated linear or branched dicarboxylic acid diester plasticizer. The compositions are formed by combining the elastic polymer and reactive ester plasticizer with a curing agent to react at least 5% by weight of the diester plasticizer to the elastic polymer. The elastomer includes natural and synthetic rubbers, such as nitrile butadiene rubber, hydrogenated nitrile butadiene rubber, chlorinated polyethylene rubber, and ethylene propylene diene monomer rubber. The plasticized elastomer compositions disclosed herein provide improved solvent immersion properties, and are useful, for example, for hoses, belts, conveyor belts, motor mounts, gaskets, automotive drive train belts, including transmission belts, roofing compounds, and the like.

### FIELD OF THE INVENTION

The present disclosure is directed to ester plasticizers and plasticized elastomers having improved properties. The disclosure is also directed to methods of preparing plasticized elastomers with improved properties such as resistance to plasticizer extraction by oils, particularly hot oils.

### BACKGROUND OF THE INVENTION

Plasticizers are frequently incorporated into elastomers to provide materials with increased flexibility, workability, or distensibility. Ester plasticizers, for example, are commonly used to improve low temperature properties and/or modify processing characteristics of elastomeric polymers. Typical ester plasticizers include adipates and phthalates such as di-2-ethylhexyl adipate (DOA or DEHA), diisodecyl adipate (DIDA), diisodecyl phthalate (DIDP), di-2-ethylhexyl phthalate (DOP or DEHP), and diisononyl phthalate (DINP). Other adipates and phthalates can be obtained from reaction of adipic acid or phthalic acid with straight-chain or branched alcohols of about 4 to 11 carbons in length. While many of these esters serve general performance applications, the demanding requirements of high performance applications, especially in the automotive industry, necessitate the continuing design and development of more advanced specialized ester plasticizers. Although high performance trimellitate ester additives such as trioctyl trimellitate (TOTM) provide marked improvements in resistance to heat aging and extraction by fluids, these esters are still extracted or volatilized from elastomer compositions under severe service conditions.

The copolymerization of high weight percentages (>10%) of α,β-unsaturated ester monomers with unsaturated nitrile group-containing monomers has been proposed to improve cold resistance of the resulting rubber compositions (see U.S. Pat. No. 6,548,604). Reduction in the required amount of ester would be desirable due to process and cost considerations, but the '604 patent teaches that materials prepared by copolymerization with low levels of ester monomer display inferior performance characteristics and impaired cold resistance compared to materials obtained using substantially larger portions of ester monomer.

U.S. Pat. No. 4,078,114 discloses a coating comprising a fluorocarbon homopolymer or copolymer, and a diallyl ester of a dicarboxylic acid. The dicarboxylic acid contains from 10 to 34 carbon atoms, excluding the two carbonyl carbon atoms. The '114 patent neither discloses nor suggests using the diallyl ester for plasticizing non-fluorocarbon polymers or elastomers.

U.S. Pat. No. 5,068,275 discloses a vulcanized rubber composition comprising hydrogenated nitrile rubber, a peroxide vulcanization system, and a polyester plasticizer obtained by the reaction of a dicarboxylic acid with a C₁ to C₁₂ alcohol. However, the '275 patent neither discloses nor suggests using unsaturated dicarboxylic acid esters as plasticizers.

U.S. Pat. No. 5,290,886 discloses a crosslinked composition comprising a thermoplastic polyolefin polymer, an olefinic rubber, and a low molecular weight ester plasticizer, including diesters and unsaturated monoesters. Neither unsaturated diesters, nor α,β-unsaturated monoesters are contemplated by the '886 patent.

U.S. Pat. No. 7,109,264 relates to cyclic diesters and bicyclic triesters useful as plasticizers for various rubber compositions. Neither linear nor branched acylic esters are disclosed by the '264 patent.

### SUMMARY OF THE INVENTION

The present disclosure is directed to plasticized elastomer compositions and methods of preparing plasticized elastomers. The plasticized elastomer compositions comprise an elastic polymer, and a reactive ester plasticizer formed from an unsaturated dicarboxylic acid and C₁ to C₃₀ alkyl alcohol. The compositions are formed by combining the elastic polymer and reactive ester plasticizer with a curing agent to react at least 5% by weight of the reactive ester plasticizer to the elastic polymer, for example, at least 10% by weight, at least 25% by weight, and/or at least 50% by weight. The elastic polymer includes natural and synthetic rubbers, such as nitrile butadiene rubber, hydrogenated nitrile butadiene rubber, chlorinated polyethylene rubber, and ethylene propylene diene monomer rubber. The plasticized elastomer compositions disclosed herein provide improved solvent immersion properties, and are useful, for example, for hoses, belts, conveyor belts, motor mounts, gaskets, automotive drive train belts, including transmission belts, roofing compounds, and the like.

The reactive ester plasticizers include straight-chain (linear) and branched diesters having at least one carbon-carbon double bond, such as maleate diesters, fumarate diesters, glutaconate diesters, itaconate diesters, hydromuconate diesters, higher alkyl dicarboxylic acid diesters, and mixtures thereof. The diesters are dialkyl esters with straight chain or branched hydrocarbon alkyl groups having 1 to 30, preferably 4 to 30, more preferably 13 to 30 carbon atoms, and having zero, one, or more carbon-carbon double bonds. Specific examples of reactive ester plasticizers of the present disclosure include ditridecyl fumarate, ditridecyl maleate, ditridecyl itaconate, and mixtures thereof.

### DETAILED DESCRIPTION

The present disclosure is directed to a plasticized elastomer composition comprising an elastic polymer, and about 0.1 to about 30% by weight ester plasticizer having formula (I):

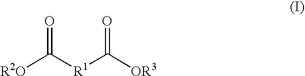

wherein R¹ is a C₂ to C₂₀ hydrocarbon chain, straight chain or branched, having one or more carbon-carbon double bonds; and R² and R³, same or different, are a C₁ to C₃₀ hydrocarbon chain, straight chain or branched, either saturated or having one or more carbon-carbon double bonds; and wherein at least 5% of the ester plasticizer has reacted with the elastic polymer.

The present disclosure also is directed to a method for preparing a plasticized elastomer and to a plasticized elastomer prepared by said method. The method comprises admixing an elastic polymer, an ester plasticizer having formula (I), and a curing agent to form a plasticized elastomer, wherein formula (I) is as defined above.

Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

### Reactive Ester Plasticizers

The reactive ester plasticizers described herein are added to one or more natural or synthetic rubbers, preferably together with a curing agent. The reactive ester plasticized elastomer compositions disclosed herein are significantly resistant to fluid extraction and render the elastomer composition with an excellent balance of flexibility, impact resistance, strength, and low temperature properties.

The reactive ester plasticizers are diesters, including diesters formed from an unsaturated dicarboxylic acid and the same or different hydrocarbon alcohols. The unsaturated dicarboxylic acid includes straight chain diacids and branched diacids, having one or more carbon-carbon double bonds. The hydrocarbon alcohols include straight-chain and branched alcohols having saturated or unsaturated hydrocarbon chains with zero, one, or more than one carbon-carbon double bond. As disclosed herein, “reactive” ester plasticizers include ester plasticizers formed from a dicarboxylic acid having at least one carbon-carbon double bond. By virtue of this at least one carbon-carbon double bond, the reactive ester plasticizer is capable of reacting during the curing process to form a covalent bond between the ester plasticizer and another molecule, such as the elastic polymer or a second molecule of the ester plasticizer. The reactive ester plasticizer is also capable of reacting to form two covalent bonds. At least 5%, preferably 10%, more preferably 25%, most preferably 50% by weight of the reactive ester plasticizer reacts during the curing process to form a covalent bond. Ester plasticizers that have reacted with the ester plasticizer to form a covalent bond resist extraction under conditions such as those detailed in the ASTM D2124 standard.

The reactive ester plasticizers have a formula (I), as follows:

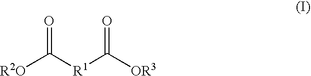

wherein R¹ is a C₂ to C₂₀, preferably C₂ to C₈, more preferably C₂ to C₄, most preferably C₂ to C₃ hydrocarbon chain, straight chain or branched, having one or more, preferably 1 to 4, more preferably 1 to 3, most preferably 1 to 2 carbon-carbon double bonds; and R² and R³, same or different, are a C₁ to C₃₀, preferably C₄ to C₃₀, more preferably C₈ to C₃₀, most preferably C₁₃ to C₃₀ hydrocarbon chain, straight chain or branched, either saturated or having one or more, preferably 1 to 6, more preferably 1 to 4, most preferably 1 to 2 carbon-carbon double bonds.

Useful reactive esters falling within formula (I) include diester structures formed by the reaction of C₄ to C₂₂, preferably C₄ to C₁₀, more preferably C₄ to C₆ alkenedioic acids, such as butenedioic acids, pentenedioic acids, and hexenedioic acids, with C₁ to C₃₀, preferably C₄ to C₃₀, more preferably C₈ to C₃₀, most preferably C₁₃ to C₃₀ alcohols, straight chain or branched, saturated or unsaturated, containing one or more, preferably 1 to 6, more preferably 1 to 4, most preferably 1 to 2 carbon-to-carbon double bonds. The alkenedioic acids have one or more, preferably 1 to 4, more preferably 1 to 3, most preferably 1 to 2 carbon-carbon double bonds. The alkenedioic acids include diacids having at least one carbon-carbon double bond at a position α,β relative to at least one acid (i.e. α,β-unsaturated acids), diacids having carbon-carbon single bonds at positions α,β relative to both acids (i.e. α,β-saturated acids), and mixtures thereof. Examples of suitable α,β-saturated diesters include, but are not limited to, cis-β-hydromuconate diesters (cis-3-hexenedioic acid diesters), trans-β-hydromuconate diesters (trans-3-hexenedioic acid diesters), and mixtures thereof. The α,β-positioned carbon-carbon double bond of α,β-unsaturated diesters is activated compared to the carbon-carbon double bonds of α,β-saturated diesters, and α,β-unsaturated diesters may be preferred for certain compositions. Examples of suitable α,β-unsaturated diesters include, but are not limited to, maleate diesters (cis-butenedioic acid diesters), fumarate diesters (trans-butenedioic acid diesters), cis-glutaconate diesters (cis-2-pentenedioic acid diesters), trans-glutaconate diesters (trans-2-pentenedioic acid diesters), itaconate diesters (methylenesuccinic acid diesters), cis-α-hydromuconate diesters (cis-2-hexenedioic acid diesters), trans-α-hydromuconate diesters (trans-2-hexenedioic acid diesters), and mixtures thereof.

The hydrocarbon chains R² and R³ of the esters of formula (I) can be any C₁ to C₃₀, preferably C₄ to C₃₀, more preferably C₈ to C₃₀, most preferably C₁₃ to C₃₀ hydrocarbon chain, straight chain or branched, either saturated or having one or more, preferably 1 to 6, more preferably 1 to 4, most preferably 1 to 2 carbon-carbon double bonds. Examples of suitable hydrocarbon chain include, but are not limited to, the hydrocarbon chain residues from the following alcohols, where the number in parentheses indicates the number of carbon atoms, and the number of double bonds, e.g., (C₂₄₋₆) indicates a hydrocarbon chain having 24 carbon atoms and 6 double bonds: hexanol (C₆₋₀); octanol (C₈₋₀); decanol (C₁₀₋₀); dodecanol (C₁₂₋₀); cis-9-dodecenol (C₁₂₋₁); tridecanol (C₁₃₋₀); tetradecanol (C₁₄₋₀); cis-9-tetradecenol (C₁₄₋₁); hexadecanol (C₁₆₋₀); cis-9-hexadecenol (C₁₆₋₁); octadecanol (C₁₈₋₀); cis-9-octadecenol (C₁₈₋₁); cis-cis-9,12-octadecadienol (C₁₈₋₂); cis-cis-cis-9,12,15-octadecatrienol (C₁₈₋₃); cis-trans-trans-9,11,13-octadecatrienol (C₁₈₋₃); octadecatetraenol (C₁₈₋₄); eicosanol (C₂₀₋₀); cis-11-eicosenol (C₂₀₋₁); eicosadienol (C₂₀₋₂); eicosatrienol (C₂₀₋₃); 5,8,11,14-eicosatetraenol (C₂₀₋₄); eicosapentaenol (C₂₀₋₅); docosanol (C₂₂); cis-13-docosenol (C₂₂₋₁); docosatetraenol (C₂₂₋₄); 4,8,12,15,19-docosapentaenol (C₂₂₋₅); docosahexaenol (C₂₂₋₆); tetracosenol (C₂₄₋₁); and 4,8,12,15,18,21-tetracosahexaenol (C₂₄₋₆). For example, R² and R³, same or different, can be octyl, nonyl, decyl, undecyl, dodecyl, tridecyl, tetradecyl, pentadecyl, or hexadecyl.

Specific examples of suitable reactive esters plasticizers include, but are not limited to, ditridecyl fumarate, ditridecyl maleate, ditridecyl itaconate, ditridecyl cis-glutaconate, ditridecyl trans-glutaconate, ditridecyl cis-α-hydromuconate, ditridecyl trans-α-hydromuconate, ditridecyl cis-β-hydromuconate, ditridecyl trans-β-hydromuconate, and mixtures thereof. Additional specific examples of suitable reactive esters plasticizers include, but are not limited to, ditetradecyl fumarate, ditetradecyl maleate, ditetradecyl itaconate, dipentadecyl fumarate, dipentadecyl maleate, dipentadecyl itaconate, dihexadecyl fumarate, dihexadecyl maleate, dihexadecyl itaconate, and mixtures thereof.

To achieve the full advantage of the plasticized elastomers described herein, the reactive ester plasticizers of formula (I) are added to an elastomer composition comprising natural and/or synthetic rubber in an amount of about 0.1 to about 30% by total weight, for example, about 0.1 to about 15% by total weight, about 0.1 to about 9% by total weight, about 1 to about 8% by total weight, about 2 to about 7% by total weight, and/or about 5 to about 7% by total weight.

Particularly useful ester plasticizers include substantially pure esters and mixtures of esters, and any one or any blend of the esters that include the reactive esters in accordance with formula (I) will function to plasticize elastomers, and provide a balance of flexibility, strength, low temperature properties, and resistance to oil extraction, with essentially no bleeding of the plasticizer to the surface of an elastomeric article. Particularly, the plasticized elastomer compositions described herein are characterized in that the resistance to extraction by hot oils and fuels is reduced.

### Elastomers

The terms “elastomer” or “elastomeric polymer” are used interchangeably herein to include natural and synthetic rubbers. Elastomers useful in the compositions described herein can be natural rubbers (NR), synthetic rubbers, and mixtures thereof. Synthetic rubbers include homopolymers of conjugated diene compounds such as isoprene, butadiene, chloroprene, and the like, for example, polyisoprene rubber (IR), polybutadiene rubber (BR), polychloroprene rubber, and the like; copolymers of the above described conjugated diene compounds with vinyl compounds such as styrene, acrylonitrile, vinyl pyridine, acrylic acid, methacrylic acid, alkyl acrylates, alkyl methacrylates, and the like, for example, styrene-butadiene copolymeric rubber (SBR), vinylpyridine-butadiene-styrene copolymeric rubber, acrylonitrile-butadiene copolymeric rubber (NBR), acrylic acid-butadiene copolymeric rubber, methacrylic acid-butadiene copolymeric rubber, methyl acrylate-butadiene copolymeric rubber, methyl methacrylate-butadiene copolymeric rubber, acrylonitrile-butadiene-styrene terpolymer, and the like; copolymers of olefins, such as ethylene, propylene, isobutylene, and the like with dienes, for example, isobutylene-isoprene copolymeric rubber (IIR); copolymers of olefins with non-conjugated dienes such as ethylene propylene diene monomer (EPDM), for example, ethylene-propylene-cyclopentadiene terpolymer, ethylene-propylene-5-ethylidene-2-norbornene terpolymer and ethylene-propylene-1,4-hexadiene terpolymer; polyalkenamers obtained by ring opening polymerization of cycloolefins, for example, polypentenamer; rubbers obtained by ring opening polymerization of oxirane rings, for example, polyepichlorohydrin rubber and polypropylene oxide rubber, and the like. Additionally, halides of the above-described various rubbers, for example, chlorinated polyethylene rubber (CPE), chlorinated isobutylene-isoprene copolymeric rubber (Cl-IIR), brominated isobutylene-isoprene copolymeric rubber (Br-IIR), fluorinated polyethylene, and the like are similarly included. Furthermore, hydrogenated and partially hydrogenated compositions of the above-described various rubbers, for example, hydrogenated butadiene rubber, hydrogenated nitrile butadiene rubber (HNBR), hydrogenated carboxylated nitrile rubber, hydrogenated styrene-butadiene rubber, hydrogenated acrylonitrile-butadiene-styrene terpolymer, and the like are similarly included.

Particularly, the compositions described herein are characterized in that solvent extraction properties of plasticized natural rubber (NR), and synthetic rubbers, e.g. hydrogenated nitrile butadiene rubber (HNBR), nitrile butadiene rubber (NBR), styrene-butadiene copolymeric rubber (SBR), polybutadiene rubber (BR), polyisoprene rubber (IR), isobutylene-isoprene copolymeric rubber, halides of these rubbers (Cl-IIR, Br-IIR), chlorinated polyethylene rubber (CPE), and copolymers of olefins with non-conjugated dienes such as ethylene propylene diene monomer (EPDM), are improved to provide the rubbers with resistance to plasticizer extraction by oils, fuels, and other fluids. Additionally, the present disclosure can be applied to other elastomers. All these elastomers may be kneaded with compounding agents conventionally used for compounding with rubber, for example, fillers, such as carbon black, silica, calcium carbonate, lignin and the like, and softening agents, such as mineral oils, vegetable oils and the like, prior to curing and then cured.

### Curing Agents

To cure an elastomer composition, a curing agent such as a peroxide or sulfur-containing curing agent is dispersed throughout the composition. Exemplary curing agents include, but are not limited to organic peroxides, sulfur, organic sulfides, and mixtures thereof. The amount of curing agent, e.g., peroxide compound, in the composition is typically from about 2 parts to about 15 parts by weight, for example from about 4 parts to about 12 parts by weight, per 100 parts by weight of natural and/or synthetic rubber, but lesser or larger amounts, for example, from about 1 to 20 parts by weight may be employed on the same basis. A preferred range is from about 5 parts to about 10 parts per 100 parts by weight of elastomer. The ratio of curing agent to ester plasticizer is typically from about 1:20 (wt/wt) to about 2:1 (wt/wt), for example from about 1:10 (wt/wt) to about 1:1 (wt/wt), but lesser or larger amounts may be employed on the same basis. Representative examples of peroxide curing agents include di(tert-butylperoxyisopropyl)benzene (PERKADOX® 14-40B-PD), 2,5-dimethyl-2,5-di(tert-butylperoxy)hexane (TRIGONOX 101-45B-PD), butyl 4,4-di(tert-butylperoxy)valerate (TRIGONOX 17-40B-PD), and 1,1-di(tert-butylperoxy)-3,3,5-trimethylcyclohexane (TRIGONOX 29-40B-PD). Representative examples of sulfur curing agents include elemental sulfur (S₈), amine disulfides, polymeric polysulfides, and sulfur olefin adducts.

The term “curing” as used herein, encompasses the term “vulcanization,” and both terms refer to the introduction of covalent bonds between rubber molecules, between a rubber molecule and a molecule of the ester plasticizer, and between molecules of the ester plasticizer. Thus, sulfur vulcanization, thiuram vulcanization, quinoid vulcanization, resin vulcanization, metal salt vulcanization, metal oxide vulcanization, polyamine vulcanization, radiation vulcanization, hexamethylenetetramine vulcanization, urethane cross-linker vulcanization and the like are included in addition to peroxide curing.

### Additives

Accelerators may be used to control the time and/or temperature required for curing/vulcanization and to improve the properties of the cured product. The accelerator(s) may be used in total amounts ranging from about 0.3 parts to about 4 parts, for example about 0.3 parts to about 1.5 parts, preferably from about 0.4 parts to about 1.0 parts, and more preferably from about 0.5 parts to about 0.8 parts by weight per 100 parts by weight of natural and/or synthetic rubbers. Suitable types of accelerators that may be used include amines, disulfides, guanidines, thioureas, thiazoles, thiurams, sulfenamides, dithiocarbamates, and xanthates. Specific examples of curing/vulcanization accelerators which can be used in the elastomer compositions described herein are thiazole-based accelerators, for example 2-mercaptobenzothiazole, bis(2-benzo-thiazolyl)disulphide, 2-(2′,4′-dinitro-phenylthio)benzothiazole, benzothiazole-2-sulphenamides, for instance N-isopropyl-benzothiazole-2-sulphenamide, N-tert-butyl-benzothiazole-2-sulphenamide, N-cyclo-hexylbenzo-thiazole-2-sulphen-amide, and 2-(morpholinothio)benzothiazole, and thiocarbamylsulphenamides, for example N,N-dimethyl-N′,N′-dicyclohexylthiocarbamoylsulphenamide, and N-(morpholinothiocarbonylthio)morpholine.

The commonly employed carbon blacks used in conventional rubber compounding applications can be used as the carbon black in this invention. Representative examples of such carbon blacks include N110, N121, N220, N231, N234, N242, N293, N299, S315, N326, N330, M332, N339, N343, N347, N351, N358, N375, N550, N683, N770, N880, and N990.

The rubber compositions described herein are compounded by methods generally known in the rubber compounding art, such as mixing the various peroxide-vulcanizable or sulfur-vulcanizable constituent rubbers with various commonly used additive materials such as, for example, sulfur donors, curing aids, such as activators and retarders, and processing additives, such as oils, resins including tackifying resins and other conventional plasticizers, fillers, pigments, fatty acids, zinc oxide, waxes, antioxidants and antiozonants, retarders, and peptizing agents. A typical amount of adhesive resins is about 0.2 parts to about 10 parts per 100 parts by weight of the natural and/or synthetic rubbers, usually about 1 part to about 5 parts.

Typical amounts of zinc oxide comprise about 2 parts to about 5 parts per 100 parts by weight of natural and/or synthetic rubbers. Typical amounts of waxes comprise about 1 part to about 5 parts per 100 parts by weight of natural and/or synthetic rubbers. Often, microcrystalline waxes are used. Typical amounts of retarders range from about 0.05 parts to about 2 parts per 100 parts by weight of natural and/or synthetic rubbers. Typical amounts of peptizers comprise about 0.1 parts to about 1 part per 100 parts by weight of natural and/or synthetic rubbers. Typical peptizers can be, for example, pentachlorothiophenol and dibenzamidodiphenyl disulfide. All additive percentages and amounts are based on the weight of natural and/or synthetic rubbers.

Curing of the elastomer composition described herein is generally carried out at conventional temperatures ranging from about 100° C. to about 200° C. Preferably, the curing is conducted at temperatures ranging from about 110° C. to about 180° C. Any of the usual curing and/or vulcanization processes may be used such as heating in a press or mold, heating with superheated steam or hot air, or in a salt bath.

Upon curing of the elastomer composition at a temperature ranging from about 100° C. to about 200° C., the composition can be used for various purposes. For example, the cured elastomer composition may be in the form of a tire, belt, seal, hose, motor mounts, gaskets and air springs. In the case of a belt, it can be used for various automotive components, such as power transmission belts, and other applications. Such belts can be built, shaped, molded, and cured by various methods which are known and will be readily apparent to those having skill in such art.

### EXAMPLES

The invention may be better understood by reference to the following examples which are not intended to be limiting, but only exemplary of specific embodiments of the disclosure. Unless otherwise indicated, parts and percentages provided below are by weight.

In the following examples, reactive ester plasticizers such as ditridecyl maleate were applied to Therban® hydrogenated nitrile butadiene rubber (HNBR). Various properties of compositions prepared with a reactive ester plasticizer were compared to the properties of compositions obtained using a non-reactive ester plasticizer. Tables I-V include processing and curing properties, original physical properties, heat aging data, low temperature data, and solvent immersion data for elastomer compositions plasticized with ditridecyl maleate or with trioctyl trimellitate (TOTM). Both ester plasticizers were evaluated at 10 parts per hundred parts by weight of HNBR (phr). Compositions were prepared by mixing all components except the curing agents in a BR Banbury mixer. Curatives were added on a two-roll mill, and the compositions were then molded using the following parameters: Press temperature=149° C., Press time=1.25×t′c(90) minutes, and surface pressure=5.75 MPa. Samples for obtaining original physical properties, heat aging data, low temperature data, and solvent immersion data were die cut from the molded sheets.

Table I shows comparative data for HNBR compositions cured with one of four different peroxides and plasticized with either ditridecyl maleate or TOTM. When compositions were cured with the same peroxide, ditridecyl maleate-containing compositions displayed similar processing and curing properties compared to TOTM-containing compositions. However, the choice of peroxide significantly affected both the physical properties of the compositions and the extent of reaction of the reactive ester plasticizer to the polymer. In particular, the HNBR composition (Example 3) prepared with the combination of ditridecyl maleate and 2,5-dimethyl-2,5-di(tert-butylperoxy)hexane (Trigonox® 101-45B-PD) lost the least weight when subjected to air oven aging for 14 days at 150° C. (% weight change=−3.3). Under the same conditions, the percent weight change of the HNBR composition prepared with TOTM was −5.4.

TABLE I

| | Example | | | | | | | |
|---|---|---|---|---|---|---|---|---|
| | 1 | 2 | 3 | 4 | 5 | 6 | 7 | 8 |
| Therban ® A3907 | 100.0 | 100.0 | 100.0 | 100.0 | 100.0 | 100.0 | 100.0 | 100.0 |
| N-990 Carbon Black | 40.0 | 40.0 | 40.0 | 40.0 | 40.0 | 40.0 | 40.0 | 40.0 |
| Naugard ® 445 | 1.0 | 1.0 | 1.0 | 1.0 | 1.0 | 1.0 | 1.0 | 1.0 |
| PE-AC-617 | 1.0 | 1.0 | 1.0 | 1.0 | 1.0 | 1.0 | 1.0 | 1.0 |
| Kadox ® 911C | 3.0 | 3.0 | 3.0 | 3.0 | 3.0 | 3.0 | 3.0 | 3.0 |
| Maglite ® DE | 3.0 | 3.0 | 3.0 | 3.0 | 3.0 | 3.0 | 3.0 | 3.0 |
| ZMTI | 0.53 | 0.53 | 0.53 | 0.53 | 0.53 | 0.53 | 0.53 | 0.53 |
| TAIC | 1.50 | 1.50 | 1.50 | 1.50 | 1.50 | 1.50 | 1.50 | 1.50 |
| Ditridecyl maleate | 10.0 | — | 10.0 | — | 10.0 | — | 10.0 | — |
| TOTM | — | 10.0 | — | 10.0 | — | 10.0 | — | 10.0 |
| Subtotal | 160.03 | 160.03 | 160.03 | 160.03 | 160.03 | 160.03 | 160.03 | 160.03 |
| Mill Addition | | | | | | | | |
| Perkadox ® 14-40B-PD | 8.0 | 8.0 | — | — | — | — | — | — |
| Trigonox ® 101-45B-PD | — | — | 8.0 | 8.0 | — | — | — | — |
| Trigonox ® 17-40B-PD | — | — | — | — | 8.0 | 8.0 | — | — |
| Trigonox ® 29-40B-PD | — | — | — | — | — | — | 8.0 | 8.0 |
| Total | 168.03 | 168.03 | 168.03 | 168.03 | 168.03 | 168.03 | 168.03 | 168.03 |
| Processing Properties | | | | | | | | |
| Viscosity and Curing Properties | | | | | | | | |
| Mooney Viscosity at 125° C. (257° F.) | | | | | | | | |
| Minimum Viscosity | 35.9 | 36.6 | 35.6 | 37.5 | 37.6 | 38.3 | 40.4 | 43.5 |
| t5, minutes | 54.7 | 49.8 | >60 | 58.4 | 18.6 | 16.5 | 7.7 | 6.4 |
| t10, minutes | >60 | >60 | >60 | >60 | 28.0 | 22.0 | 10.1 | 8.0 |
| t35, minutes | >60 | >60 | >60 | >60 | >60 | 43.1 | 20.2 | 13.5 |
| Oscillating Disc Rheometer at 170° C. | | | | | | | | |
| (338° F.) | | | | | | | | |
| M_{L} | 7.6 | 8.4 | 8.0 | 8.6 | 9.3 | 9.5 | 10.7 | 11.9 |
| M_{H} | 40.5 | 46.7 | 33.5 | 58.4 | 26.4 | 40.1 | 23.0 | 33.4 |
| t_{S}2, minutes | 2.1 | 1.9 | 2.5 | 2.0 | 1.6 | 1.4 | 1.0 | 1.1 |
| t′c(90), minutes | 21.8 | 7.8 | 10.7 | 12.7 | 5.0 | 5.2 | 2.5 | 2.7 |
| Original Physical Properties | | | | | | | | |
| Stress @ 300% Elongation, MPa | 16.5 | 14.4 | 8.9 | 14.0 | 3.9 | 6.3 | 2.3 | 4.2 |
| Tensile Ultimate, MPa | 17.1 | 17.0 | 16.9 | 15.2 | 14.9 | 17.7 | 23.8 | 25.9 |
| Elongation @ Break, % | 315 | 335 | 450 | 310 | 625 | 525 | 725 | 675 |
| Hardness Duro A, pts. | 60 | 58 | 59 | 60 | 57 | 57 | 53 | 57 |
| Air Oven Aging, 7 days @150° C. | | | | | | | | |
| (302° F.) | | | | | | | | |
| Stress Change, % | 67 | 73 | 90 | 79 | 82 | 146 | 174 | 84 |
| Tensile Change, % | −7 | −2 | −12 | 4 | 5 | 3 | −48 | −41 |
| Elongation Change, % | −21 | −24 | −27 | −16 | −16 | −12 | −12 | −13 |
| Hardness Change, pts. | 6 | 8 | 7 | 7 | 8 | 6 | 12 | 7 |
| Weight Change, % | −3.4 | −3.4 | −3.2 | −4.0 | −5.0 | −3.2 | −5.5 | −3.7 |
| Air Oven Aging, 14 days @150° C. | | | | | | | | |
| (302° F.) | | | | | | | | |
| Stress Change, % | 76 | 100 | 94 | 91 | 97 | 179 | 205 | 116 |
| Tensile Ultimate, MPa | 14.8 | 16.3 | 14.7 | 15.9 | 13.8 | 15.6 | 10.3 | 13.2 |
| Elongation Change, % | −14 | −18 | −18 | −11 | −12 | −10 | −20 | −9 |
| Hardness Change, pts. | 8 | 10 | 7 | 9 | 9 | 9 | 13 | 8 |
| Weight Change, % | −3.6 | −4.9 | −3.3 | −5.4 | −5.4 | −4.7 | −6.1 | −4.4 |

The neat volatilities of ditridecyl maleate and TOTM are provided in Table II. Although the molecular weights of the two esters are similar, weight loss of neat ester after heating differs considerably. Specifically, neat ditridecyl maleate is significantly more volatile than neat TOTM, in contrast to the decreased volatility of ditridecyl maleate compared to TOTM when the esters are incorporated into HNBR compositions as described above.

TABLE II

| Neat Plasticizer | Ditridecyl maleate | TOTM |
|---|---|---|
| % weight change, 2 hours @ 155° C. | −2.0 | −0.05 |
| % weight change, 22 hours @ 155° C. | −14.2 | −6.3 |

Further evaluations were performed on the compositions (Examples 3 and 4) cured with 2,5-dimethyl-2,5-di(tert-butylperoxy)hexane (Trigonox 101-45B-PD).

The results of Soxhlet extraction of compositions 3 and 4 are provided in Table III. As the plasticizer represents 6.2% by weight of the composition (10 parts of 160.03 parts=6.2%), TOTM was extracted completely (6.2% extracted of 6.2% total weight=100%). Ditridecyl maleate outperformed TOTM, with only 32% of the added ditridecyl maleate extracted (2.0% extracted of 6.2% total weight=32%). Thus; about 68% of ditridecyl maleate remained associated with the polymer backbone through covalent and/or non-covalent interactions.

TABLE III

Example

| | 3 | 4 |
|---|---|---|
| Plasticizer | Ditridecyl maleate | TOTM |
| % extracted, ASTM D2124 | 2.0 | 6.2 |

Table IV shows low temperature properties, oil and water extraction properties, and fuel immersion properties for Examples 3 and 4. When subjected to ASTM 1 Oil extraction, the reactive ester-containing HNBR composition (compound 3) experienced only a negligible weight change (% weight change=−0.2), while a more significant weight loss (% weight change=−5.3) was observed with the TOTM-containing HNBR composition (compound 4). Both compounds 3 and 4 increased in weight upon exposure to IRM 903 Oil (compound 3: % weight change=15; compound 4: % weight change=5.5), indicating that the compounds absorbed the fluid with minimal extraction of the ester. Weight gain was also observed with distilled water (compound 3: % weight change=5.6; compound 4: % weight change=3.4), further suggesting that fluids were absorbed by the compositions with minimal loss of the ester plasticizer. In addition, compound 3 demonstrated exceptional resistance to extraction by Fuel C (% weight loss after dry out=−0.8%) compared to compound 4 (% weight loss after dry out=−5.1%).

TABLE IV

| | Example | |
|---|---|---|
| | 3 | |
| | Ditridecyl | 4 |
| | maleate | TOTM |
| Plasticizer | Trigonox | Trigonox |
| Peroxide | 101-45B-PD | 101-45B-PD |
| Low Temperature Properties | | |
| Low Temperature Impact - Brittleness | | |
| Brittle Point, as molded, all pass, ° C. | −42 | −44 |
| Low Temperature Torsion - Gehman | | |
| As molded, Relative Modulus | | |
| T10, ° C. | −23 | −26 |
| Apparent Modulus of Rigidity | 121.4 | 133.5 |
| ASTM 1 oil, 168 hrs @ 135° C. (275° F.) | | |
| Stress Change, % | −6 | 22 |
| Tensile Change, % | −5 | 5 |
| Elongation Change, % | −7 | −6 |
| Hardness Change, pts. | 0 | 3 |
| Volume Change, % | −0.2 | −6.0 |
| Weight Change, % | −0.2 | −5.3 |
| IRM 903 oil, 168 hrs @ 135° C. (275° F.) | | |
| Stress Change, % | 4 | 22 |
| Tensile Change, % | −41 | −20 |
| Elongation Change, % | −30 | −24 |
| Hardness Change, pts. | −6 | 0 |
| Volume Change, % | 18 | 6.5 |
| Weight Change, % | 15 | 5.5 |
| Distilled water, 70 hrs @ 100° C. | | |
| Stress Change, % | 6 | 19 |
| Tensile Change, % | 1 | 11 |
| Elongation Change, % | 3 | 0 |
| Hardness Change, pts. | 1 | 1 |
| Volume Change, % | 6.1 | 3.6 |
| Weight Change, % | 5.6 | 3.4 |
| ASTM Fuel C Immersion, 70 hrs @ 23° C. | | |
| Stress Change, % | −20 | 7 |
| Tensile Change, % | −74 | −76 |
| Elongation Change, % | −53 | −60 |
| Hardness Change, pts. | −27 | −14 |
| Volume Change, % | 68 | 32 |
| Weight Change, % | 49 | 35 |
| ASTM Fuel C Dry Out, 22 hrs @ 70° C. | | |
| Hardness, Duro A, pts. | 59 | 62 |
| Hardness Change, pts. | 0 | 2 |
| Volume Change, % | 0.0 | −5.2 |
| Weight Change, % | −0.8 | −5.1 |

Compared to the standard TOTM-containing composition, the reactive ester-containing composition similarly displayed satisfactory low temperature properties. As shown in Table IV, brittleness and Gehman values are nearly equivalent for compounds 3 and 4. In addition, glass transition data for the compositions were determined by differential scanning calorimetry (DSC). T_{g} values for the HNBR compositions plasticized with ditridecyl maleate further illustrate the efficacy of the disclosed plasticizers. As shown in Table V, the disclosed plasticizers provide glass transition temperatures for both the original and the heat-aged HNBR compositions which are comparable to those achieved with the non-reactive ester plasticizer TOTM.

TABLE V

| | Example | |
|---|---|---|
| | 3 | 4 |
| Plasticizer | Ditridecyl maleate | TOTM |
| T_{g}, Original | −25.0 | −26.3 |
| T_{g}, Heat aged, 7 days @ 150° C. | −21.4 | −21.3 |

TABLE VI

| | Materials List for Tables I-V | |
|---|---|---|
| Material | Chemical Description | Supplier |
| Therban ® A3907 | Hydrogenated nitrile butadiene rubber | Bayer |
| N-990 | Carbon Black | |
| Naugard ® 445 | | |
| PE-AC-617 | | |
| Kadox ® 911C | Zinc Oxide | The HallStar Company |
| Maglite ® DE | Magnesium Oxide | The HallStar Company |
| ZMTI | Zinc 2-mercaptotoluimidazole | |
| TAIC | Triallyl Isocyanate | |
| Ditridecyl Maleate | Ditridecyl Maleate | The HallStar Company |
| TOTM | Trioctyl Trimellitate | The HallStar Company |
| Perkadox ® 14-40B-PD | Di(tert-butylperoxyisopropyl) benzene | Akzo Nobel |
| Trigonox ® 101-45B-PD | 2,5-dimethyl-2,5-di(tert-butylperoxy) hexane | Akzo Nobel |
| Trigonox ® 17-40B-PD | Butyl 4,4-di(tert-butylperoxy) valerate | Akzo Nobel |
| Trigonox ® 29-40B-PD | 1,1-di(tert-butylperoxy)-3,3,5-trimethylcyclohexane | Akzo Nobel |

What is claimed is:

1. A plasticized elastomer composition comprising an elastic polymer, and about 0.1 to about 30% by weight ester plasticizer having formula (I): 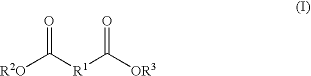
wherein R¹ is a C₂ to C₂₀ hydrocarbon chain, straight chain or branched, having one or more carbon-carbon double bonds; and
R² and R³, same or different, are a C₁ to C₃₀ hydrocarbon chain, straight chain or branched, either saturated or having one or more carbon-carbon double bonds; and
wherein at least 5% of the ester plasticizer has reacted with the elastic polymer.

2. The composition of claim 1, wherein R¹ is a C₂ to C₈ hydrocarbon chain, straight chain or branched, having one or more carbon-carbon double bonds.

3. The composition of claim 1, wherein R¹ is a C₂ to C₄ hydrocarbon chain, straight chain or branched, having one or more carbon-carbon double bonds.

4. The composition of claim 1, wherein R² and R³, same or different, are a C₄ to C₃₀ hydrocarbon chain, straight chain or branched, either saturated or having one or more carbon-carbon double bonds.

5. The composition of claim 1, wherein R² and R³, same or different, are a C₁₃ to C₃₀ hydrocarbon chain, straight chain or branched, either saturated or having one or more carbon-carbon double bonds.

6. The composition of claim 1, wherein R² and R³, same or different, are selected from the group consisting of octyl, nonyl, decyl, undecyl, dodecyl, tridecyl, tetradecyl, pentadecyl, and hexadecyl.

7. The composition of claim 1, wherein R² and R³ are tridecyl.

8. The composition of claim 1, wherein the ester plasticizer having formula (I) is selected from the group consisting of maleate diesters, fumarate diesters, cis-glutaconate diesters, trans-glutaconate diesters, itaconate diesters, cis-hydromuconate diesters, trans-hydromuconate diesters, and mixtures thereof.

9. The composition of claim 1, wherein the ester plasticizer having formula (I) is selected from the group consisting of ditridecyl fumarate, ditridecyl maleate, ditridecyl itaconate, ditetradecyl fumarate, ditetradecyl maleate, ditetradecyl itaconate, dipentadecyl fumarate, dipentadecyl maleate, dipentadecyl itaconate, dihexadecyl fumarate, dihexadecyl maleate, dihexadecyl itaconate, and mixtures thereof.

10. The composition of claim 1, wherein the ester plasticizer having formula (I) has at least one carbon-carbon double bond at a position α,β relative to at least one ester.

11. The composition of claim 1, wherein the elastic polymer is selected from the group consisting of natural rubber, nitrile butadiene rubber, hydrogenated nitrile butadiene rubber, chlorinated polyethylene rubber, ethylene propylene diene monomer rubber, polyisoprene rubber, polybutadiene rubber, polychloroprene rubber, styrene-butadiene copolymeric rubber, vinylpyridine-butadiene-styrene copolymeric rubber, acrylic acid-butadiene copolymeric rubber, methacrylic acid-butadiene copolymeric rubber, methyl acrylate-butadiene copolymeric rubber, methyl methacrylate-butadiene copolymeric rubber, acrylonitrile-butadiene-styrene terpolymer, isobutylene-isoprene copolymeric rubber, ethylene-propylene-cyclopentadiene terpolymer, ethylene-propylene-5-ethylidene-2-norbornene terpolymer, ethylene-propylene-1,4-hexadiene terpolymer, polypentenamer rubber, polyepichlorohydrin rubber, polypropylene oxide rubber, chlorinated isobutylene-isoprene copolymeric rubber, brominated isobutylene-isoprene copolymeric rubber, fluorinated polyethylene, hydrogenated butadiene rubber, hydrogenated carboxylated nitrile rubber, hydrogenated styrene-butadiene rubber, hydrogenated acrylonitrile-butadiene-styrene terpolymer, and mixtures thereof.

12. The composition of claim 1, wherein the ester plasticizer having formula (I) is added in an amount of about 0.1 to about 15% by weight.

13. The composition of claim 1, wherein the ester plasticizer having formula (I) is added in an amount of about 0.1 to about 9% by weight.

14. The composition of claim 1, wherein at least 10% of the ester plasticizer has reacted with the elastic polymer.

15. The composition of claim 1, wherein at least 25% of the ester plasticizer has reacted with the elastic polymer.

16. The composition of claim 1, wherein at least 50% of the ester plasticizer has reacted with the elastic polymer.

17. A method for preparing a plasticized elastomer comprising admixing an elastic polymer, an ester plasticizer having formula (I), and a curing agent to form a plasticized elastomer: 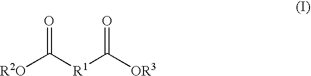
wherein R¹ is a C₂ to C₂₀ hydrocarbon chain, straight chain or branched, having one or more carbon-carbon double bonds; and
R² and R³, same or different, are a C₁ to C₃₀ hydrocarbon chain, straight chain or branched, either saturated or having one or more carbon-carbon double bonds.

18. The method of claim 17, wherein R¹ is a C₂ to C₈ hydrocarbon chain, straight chain or branched, having one or more carbon-carbon double bonds.

19. The method of claim 17, wherein R¹ is a C₂ to C₄ hydrocarbon chain, straight chain or branched, having one or more carbon-carbon double bonds.

20. The method of claim 17, wherein R² and R³, same or different, are a C₄ to C₃₀ hydrocarbon chain, straight chain or branched, either saturated or having one or more carbon-carbon double bonds.

21. The method of claim 17, wherein R² and R³, same or different, are a C₁₃ to C₃₀ hydrocarbon chain, straight chain or branched, either saturated or having one or more carbon-carbon double bonds.

22. The method of claim 17, wherein R² and R³, same or different, are selected from the group consisting of octyl, nonyl, decyl, undecyl, dodecyl, tridecyl, tetradecyl, pentadecyl, and hexadecyl.

23. The method of claim 17, wherein R² and R³ are tridecyl.

24. The method of claim 17, wherein the ester plasticizer having formula (I) is selected from the group consisting of maleate diesters, fumarate diesters, cis-glutaconate diesters, trans-glutaconate diesters, itaconate diesters, cis-hydromuconate diesters, trans-hydromuconate diesters, and mixtures thereof.

25. The method of claim 17, wherein the ester plasticizer having formula (I) is selected from the group consisting of ditridecyl fumarate, ditridecyl maleate, ditridecyl itaconate, ditetradecyl fumarate, ditetradecyl maleate, ditetradecyl itaconate, dipentadecyl fumarate, dipentadecyl maleate, dipentadecyl itaconate, dihexadecyl fumarate, dihexadecyl maleate, dihexadecyl itaconate, and mixtures thereof.

26. The method of claim 17, wherein the ester plasticizer having formula (I) has at least one carbon-carbon double bond at a position α,β relative to at least one ester.

27. The method of claim 17, wherein the elastic polymer is selected from the group consisting of natural rubber, synthetic rubber, nitrile butadiene rubber, hydrogenated nitrile butadiene rubber, chlorinated polyethylene rubber, ethylene propylene diene monomer rubber, polyisoprene rubber, polybutadiene rubber, polychloroprene rubber, styrene-butadiene copolymeric rubber, vinylpyridine-butadiene-styrene copolymeric rubber, acrylic acid-butadiene copolymeric rubber, methacrylic acid-butadiene copolymeric rubber, methyl acrylate-butadiene copolymeric rubber, methyl methacrylate-butadiene copolymeric rubber, acrylonitrile-butadiene-styrene terpolymer, isobutylene-isoprene copolymeric rubber, ethylene-propylene-cyclopentadiene terpolymer, ethylene-propylene-5-ethylidene-2-norbornene terpolymer, ethylene-propylene-1,4-hexadiene terpolymer, polypentenamer rubber, polyepichlorohydrin rubber, polypropylene oxide rubber, chlorinated isobutylene-isoprene copolymeric rubber, brominated isobutylene-isoprene copolymeric rubber, fluorinated polyethylene, hydrogenated butadiene rubber, hydrogenated carboxylated nitrile rubber, hydrogenated styrene-butadiene rubber, hydrogenated acrylonitrile-butadiene-styrene terpolymer, and mixtures thereof.

28. The method of claim 17, wherein the curing agent is selected from the group consisting of an organic peroxide, sulfur, an organic sulfide, and mixtures thereof.

29. The method of claim 17, wherein the curing agent is an organic peroxide selected from the group consisting of di(tert-butylperoxyisopropyl)benzene, 2,5-dimethyl-2,5-di(tert-butylperoxy)hexane, butyl 4,4-di(tert-butylperoxy)valerate, 1,1-di(tert-butylperoxy)-3,3,5-trimethylcyclohexane, and mixtures thereof.

30. The method of claim 17, wherein the ester plasticizer having formula (I) is added in an amount of about 0.1 to about 30% by weight.

31. The method of claim 17, wherein the ester plasticizer having formula (I) is added in an amount of about 0.1 to about 15% by weight.

32. The method of claim 17, wherein the ester plasticizer having formula (I) is added in an amount of about 0.1 to about 9% by weight.

33. The method of claim 17, wherein the curing agent is added in an amount of about 2 parts to about 15 parts by weight per 100 parts by weight of elastic polymer.

34. The method of claim 17, wherein the curing agent is added in an amount of about 4 parts to about 12 parts by weight per 100 parts by weight of elastic polymer.

35. The method of claim 17, wherein at least 5% of the ester plasticizer has reacted with the elastic polymer.

36. The method of claim 17, wherein at least 10% of the ester plasticizer has reacted with the elastic polymer.

37. The method of claim 17, wherein at least 25% of the ester plasticizer has reacted with the elastic polymer.

38. The method of claim 17, wherein at least 50% of the ester plasticizer has reacted with the elastic polymer.

39. The method of claim 17, further comprising heating the mixture at a temperature from about 100° C. to about 200° C.

40. A plasticized elastomer prepared by the method of claim 17.
